(19) United States
(12) Patent Application Publication
(10) Pub. No.: US 2021/0232295 A1
(43) Pub. Date: Jul. 29, 2021

(54) CONTROL METHOD FOR DISPLAYED PICTURE AND DISPLAY SYSTEM THEREOF

(71) Applicant: QISDA CORPORATION, Taoyuan City (TW)

(72) Inventors: Chen-Yang Hu, Taoyuan City (TW); Yu-Fu Fan, Taoyuan City (TW); Hung-Wu Lin, Taichung City (TW); Wan-Wei Chi, Taoyuan City (TW); Chang-Cheng Chen, Miaoli County (TW)

(21) Appl. No.: 17/146,497

(22) Filed: Jan. 12, 2021

(30) Foreign Application Priority Data
Jan. 23, 2020 (CN) 202010076860.9

(51) Int. Cl. G06F 3/0484; G06F 3/0354; G06F 3/14

(52) U.S. Cl. CPC G06F 3/04845; G06F 3/14; G06F 3/03543

(57) ABSTRACT

A control method of displayed picture for a display includes: displaying a displayed picture, wherein the displayed picture includes a first picture area and a second picture area, the first picture area displays an image signal provided by a first host, the second picture area displays an image signal provided by a second host; moving a cursor in the displayed picture to a first boundary of the second picture area where the cursor has first positioning coordinates; dragging the first boundary by the cursor towards the first picture area, such that the cursor is moved to second positioning coordinates; and updating an appearance of the second picture area according to the second positioning coordinates.

### BACKGROUND OF THE INVENTION

### 1. Field of the Invention

The present invention relates to a control method for a displayed picture and a display system thereof, and more particularly, to a control method for a displayed picture and a display system thereof capable of effectively adjusting a layout of the displayed picture when the display system is operated in a picture-in-picture (PIP) or a picture-by-picture (PBP) function.

### 2. Description of the Prior Art

Conventional display systems may support display of two pictures in one display apparatus at the same time, e.g. picture-in-picture (PIP) function or picture-by-picture (PBP) function. The PIP may process more than two image signals, such that a major picture is displayed on a major picture area of the display apparatus and a secondary picture area is displayed with a size equal to 1/n of the major picture area on the display apparatus. Alternatively, the PBP may process more than two image signals, such that more than two pictures are simultaneously displayed on the display apparatus based on an arrangement rule, e.g. parallel arrangement or other arrangement methods.

When the conventional display apparatus uses the PIP function or the PBP function, an on-screen display (OSD) function may be utilized for adjusting a layout of the display apparatus. In order for a user to select a display arrangement (e.g. two pictures are displayed horizontally, vertically or with unequal sizes on the display apparatus) the menu of the OSD function must be turned on. The user is restricted to the display arrangements provided by the OSD function of the display apparatus, and cannot further adjust the appearance of the display to make it more suitable for browsing or other operations. Therefore, improvements to the prior art are necessary.

### SUMMARY OF THE INVENTION

The present invention provides a control method for a displayed picture and a display system thereof, which effectively adjusts a layout of the displayed picture when the display system is operated in a picture-in-picture (PIP) or a picture-by-picture (PBP) function to improve upon the prior art.

An embodiment of the present invention discloses a control method of a displayed picture for a display, comprising: displaying a displayed picture, wherein the displayed picture includes a first picture area and a second picture area, the first picture area displays an image signal provided by a first host, and the second picture area displays an image signal provided by a second host; moving a cursor in the displayed picture to a first boundary of the second picture area where the cursor has a first positioning coordinate; using the cursor to drag the first boundary towards the first picture area, such that the cursor is moved to a second positioning coordinate; and updating an appearance of the second picture area according to the second positioning coordinate.

Another embodiment of the present invention discloses a display system, comprising: a first host, configured to provide a first image signal; a second host, configured to provide a second image signal; a display, comprising a screen, configured to display a displayed picture, the displayed picture including a first picture area and a second picture area; and a controller, configured to control the first image signal displayed in the first picture area and the second image signal displayed in the second picture area; and a mouse, configured to move a cursor in the displayed picture to a first boundary of the second picture area, and to drag the cursor to the first boundary towards the first picture area when the mouse is pressed, such that the cursor is moved to a second positioning coordinate, and the controller is configured to update the appearance of the second picture area according to the second positioning coordinate when the mouse is released.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a display system according to an embodiment of the present invention.

FIGS. 2-6 are schematic diagrams of a displayed picture of the display system using a picture-by-picture function according to an embodiment of the present invention.

FIGS. 7-8 are schematic diagrams of the displayed picture of the display system using a picture-in-picture function according to an embodiment of the present invention.

FIGS. 9-10 are schematic diagrams of a control process of the displayed picture of the display system using the picture-by-picture function according to an embodiment of the present invention.

FIG. 11 is a schematic diagram of a control process of the displayed picture of the display system using the picture-in-picture function according to an embodiment of the present invention.

### DETAILED DESCRIPTION

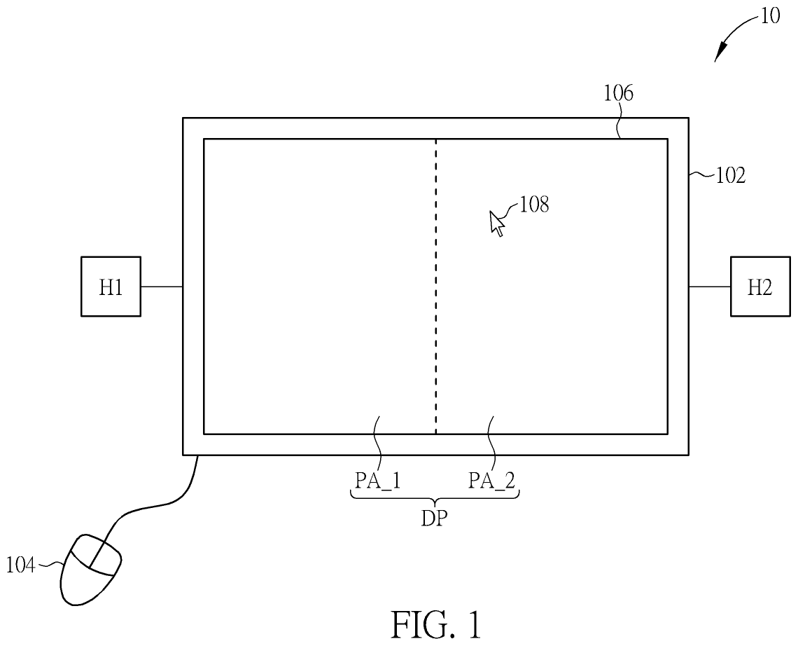

Refer to FIG. 1, which is a schematic diagram of a display system 10 according to an embodiment of the present invention. The display system 10 includes a first host H1, a second host H2, a display 102 and a mouse 104. The first host H1 is configured to provide a first image signal and the second host H2 is configured to provide a second image signal. The display 102 includes a screen 106 and a controller (not depicted in the figures), wherein the screen 106 is configured to display a displayed picture DP having a first picture area PA_1 and a second picture area PA_2. The controller is configured to control the first image signal and the second image signal to be displayed on the first picture area PA_1 or the second picture area PA_2. For example, the first host H1 and the second host H2 are respectively connected to two input ports of the display 102 to respectively provide the first image signal and the second image signal. The displayed picture DP displayed by the display 102, the first host H1 and the second host H2 are operated in an environment of a Keyboard/Video/Mouse (KVM) switching program. Thus, when the display system 10 is operated according to a picture-in-picture (PIP) function or a picture-by-picture (PBP) function, the controller of the display 102 may control the displayed picture DP of the screen 106 to present the first picture area PA_1 and the second picture area PA_2 side-by-side, wherein the first picture area PA_1 displays the first image signal from the first host H1 and the second picture area PA_2 displays the second image signal from the second host H2. In another embodiment, when the first host and the second host are identical, a graphics card of the host may provide two image signals to the two inputs of the display 102 and simultaneously transmit the first image signal and the second image signal to the display 102.

A conventional display may only be adjusted by an on-screen display (OSD) function of the display when operated according to the PIP function or the PBP function, i.e. a user may only select a layout from a menu provided by the OSD function and cannot adjust the layout according to individual requirements. Therefore, the display system 10 according to an embodiment of the present invention provides a control method for the displayed picture, which effectively adjusts the layout of the displayed picture by the mouse 104 to adjust the displayed picture DP of the display 102. In addition, the mouse 104 according to an embodiment of the present invention may connect to the display system 10, the first host H1 or the second host H2, such that the cursor 108 in the displayed picture DP may be controlled by signals transmitted by the connections. Moreover, the cursor 108 may be controlled by a control unit of the display 102, the first host H1 or the second host H2.

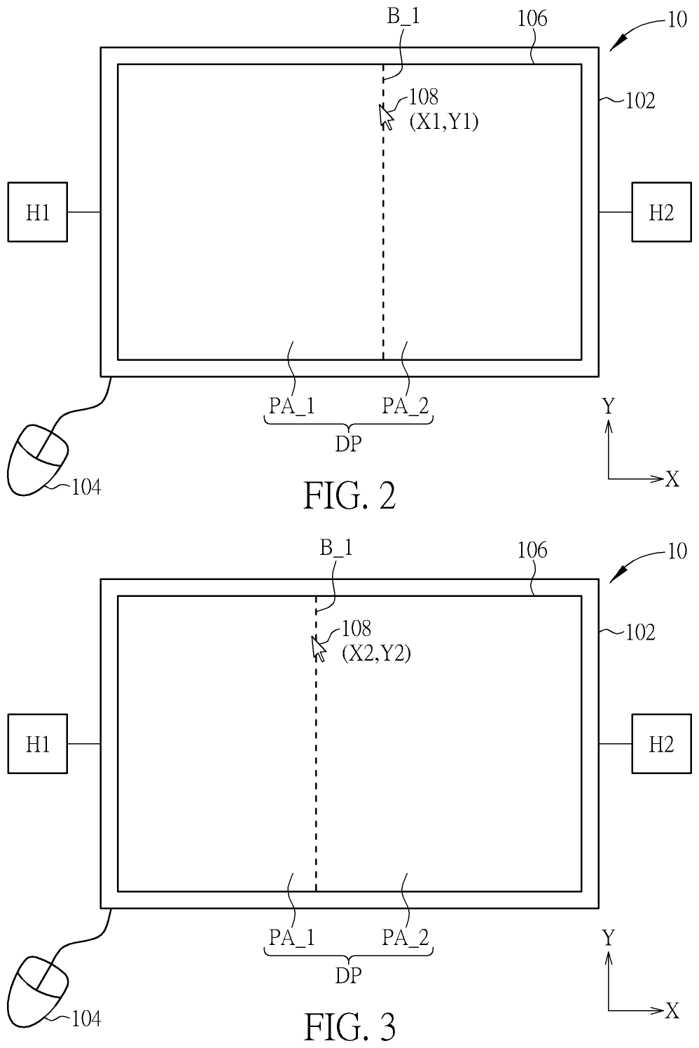

Refer to FIG. 2 and FIG. 3 for a description of an operation method of the control method according to an embodiment of the displayed picture of the display system 10. FIG. 2 and FIG. 3 are schematic diagrams of the displayed picture DP of the display system 10 using the PBP function according to an embodiment of the present invention. The first picture area PA_1 of the displayed picture DP is utilized for displaying the first image signal provided by the first host H1 and the second picture area PA_2 is utilized for displaying the second image signal provided by the second host H2. When the user is going to adjust an appearance or a layout (e.g. size or location) of the first picture area PA_1 or the second picture area PA_2 of the displayed picture DP, a cursor 108 in the displayed picture DP may be moved by the mouse 104 to adjust the layout of the first picture area PA_1 and the second picture area PA_2 in the displayed picture DP. For example, as shown in FIG. 2, when the cursor 108 is moved to a first boundary B_1 between the first picture area PA_1 and the second picture area PA_2, the cursor 108 has first positioning coordinates (X1, Y1). Then, as shown in FIG. 3, the user presses the mouse 104 to use the cursor 108 to drag the first boundary B_1 towards the first picture area PA_1, such that the cursor 108 is moved to second positioning coordinates (X2, Y2). After the mouse 104 is released, the controller of the display 102 may update the appearance or layout of the second picture area PA_2; for example, the controller of the display 102 may take X=X2 of the second positioning coordinates (X2, Y2) as a baseline to adjust the boundary of the second picture area PA_2 in the displayed picture DP, such that the appearance of the first picture area PA_1 and the second picture area PA_2 of the displayed picture DP is as shown in FIG. 3.

In detail, before the first boundary B_1 is dragged via the cursor 108 towards the first picture area PA_1, the display 102 may provide a first location information of the second picture area PA_2 to the first host H1, wherein the first location information may include coordinates of the boundary of the second picture area PA_2. Therefore, an operation system (e.g. Windows operating system) of the first host H1 may determine the first boundary B_1 of the second picture area PA_2 according to the first location information of the second picture area PA_2. When the user presses the mouse 104 to select the first boundary B_1 with the cursor 108, and drags the cursor 108 towards the first picture area PA_1, the first host H1 may determine a second location information according to the second positioning coordinates (X2, Y2), and then transmits the second location information to the display 102. As such, the display 102 may vary the displayed appearance of the second picture area PA_2 in the displayed picture DP according to the second location information. Another embodiment of the present invention is that a location of the cursor 108 is transmitted to the controller of the display 102, such that when the cursor 108 selects the first boundary B_1 and drags the first boundary B_1 to the second positioning coordinates (X2, Y2), which is towards the first picture area PA_1, the controller of the display 102 may vary the appearance of the first picture area PA_1 and the second picture area PA_2 according to the second positioning coordinates (X2, Y2) and transmit the information to corresponding host. Notably, the above appearance may be variations of size or displacement of the displayed picture.

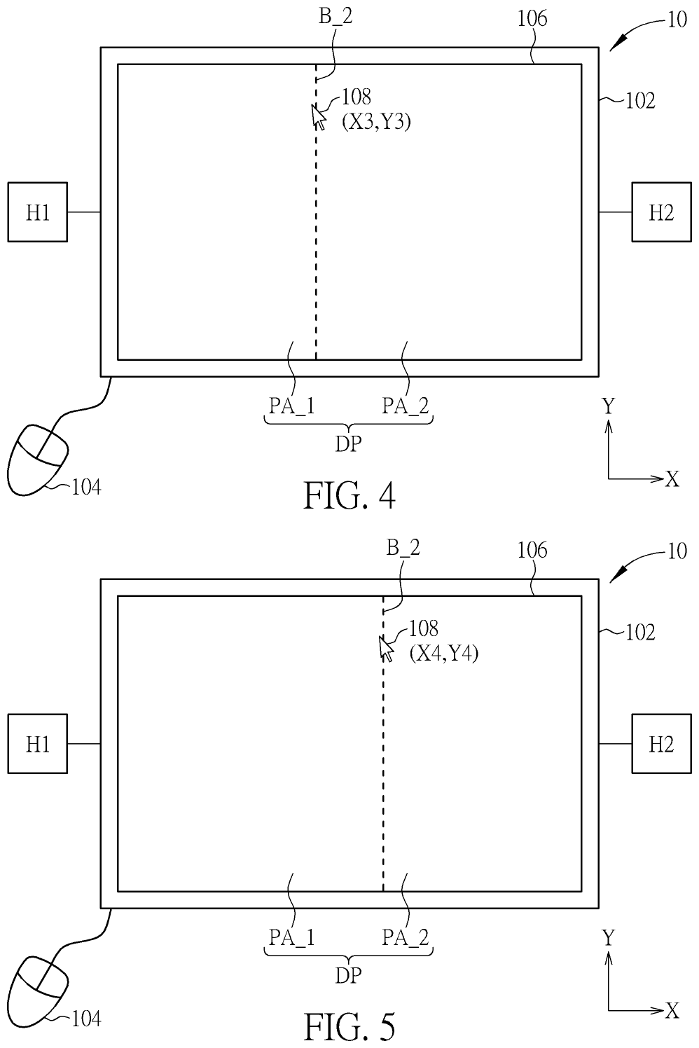

Refer to FIG. 4 and FIG. 5, which are schematic diagrams of the displayed picture DP of the display system 10 using the picture-by-picture function according to another embodiment of the present invention. In FIG. 2 and FIG. 3, the mouse 104, which is pressed by the user, selects the first boundary B_1 via the cursor 108 and the cursor 108 is dragged from the second picture area PA_2 towards the first picture area PA_1. In FIG. 4 and FIG. 5, the mouse 104, which is pressed by the user, selects the first boundary B_1 via the cursor 108 and the cursor 108 is dragged from the first picture area PA_1 towards the second picture area PA_2 to adjust the layout of the displayed picture DP. In detail, as shown in FIG. 4, when the cursor 108 is moved to a second boundary B_2 between the first picture area PA_1 and the second picture area PA_2, the cursor 108 has third positioning coordinates (X3, Y3). Then, as shown in FIG. 5, the mouse 104 is pressed by the user to use the cursor 108 to drag the second boundary B_2 towards the second picture area PA_2, such that the cursor 108 is moved to a location with fourth positioning coordinates (X4, Y4) and the mouse 104 is released. The controller of the display 102 may update the appearance of the second picture area PA_2 according to the fourth positioning coordinates (X4, Y4), e.g. the controller may adjust the boundary of the displayed picture DP based on X=X4 of the fourth positioning coordinates (X4, Y4), such that the appearance of the first picture area PA_1 and the second picture area PA_2 may be as shown in FIG. 5.

In detail, before the second boundary B_1 is dragged towards the second picture area PA_2 via the cursor 108, the display 102 provides a third location information of the second picture area PA_2 to the second host H2, such that the second host H2 may determine the second boundary B_2 of the second picture area PA_2 according to the third location information of the second picture area PA_2. When the mouse 104, which is pressed by the user, selects the second boundary B_2 via the cursor 108 and the cursor 108 is dragged towards the second picture area PA_2, the second host H2 may determine a fourth location information based on the fourth positioning coordinates (X4, Y4) and then transmit the fourth location information to the display 102. In this way, the display 102 may vary the appearance or layout of the second picture area PA_2 on the displayed picture DP based on the fourth location information.

In addition, in another embodiment, when the cursor 108 is located in the first picture area PA_1, a first hot key is activated (e.g. F5 on a keyboard connected to the display system 10) to inform the controller of the display 102, and when the cursor 108 is moved to the second picture area PA_2, a second hot key is activated (e.g. F7 on the keyboard) to inform the controller to exchange picture contents of the first picture area PA_1 and the second picture area PA_2.

Notably, exchanging the first picture area PA land the second picture area PA_2 of the displayed picture DP are not limited to two picture areas; when the displayed picture DP has more than two picture areas, i.e. when the displayed picture DP is divided into three parts or multiple parts, the appearance of the displayed picture DP may be adjusted to exchange the contents of any two of the picture areas. Such implementation is not limited to the above embodiments. Any system which uses the above method to switch at least two picture areas also belongs to the scope of the present invention.

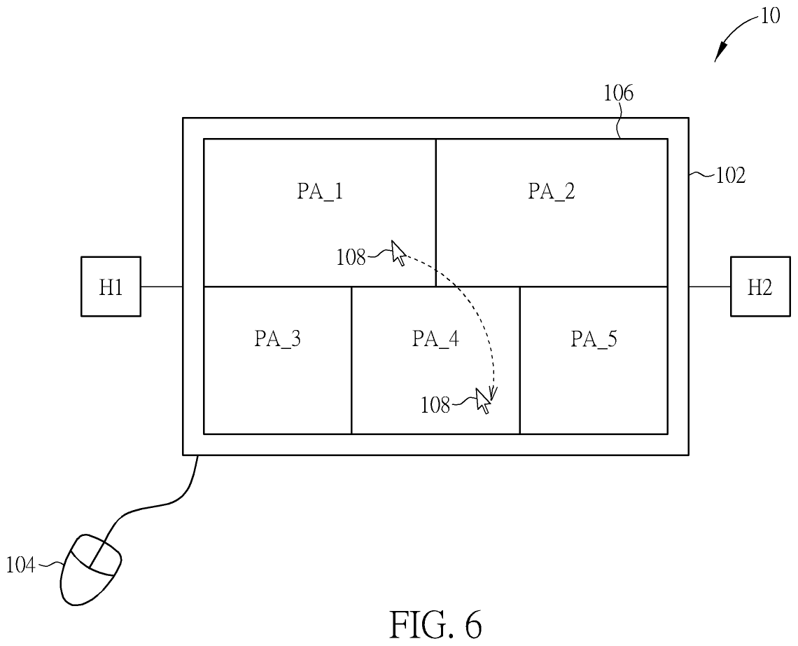

Refer to FIG. 6, which is a schematic diagram of the displayed picture DP of the display system 10 using the picture-by-picture function according to an embodiment of the present invention. As shown in FIG. 6, when the displayed picture DP includes the first picture area PA_1, the second picture area PA_2, a third picture area PA_3, a fourth picture area PA_4 and a fifth picture area PA_5, the mouse 104 may be pressed or the hot key on the keyboard may be activated by the user to select the first picture area PA_1, and then the cursor 108 is moved to another picture area (e.g. the fourth picture area PA_4) to exchange the displayed picture of the first picture area PA_1 and the fourth picture area PA_4.

The display system 10 according to the embodiments of the present invention may be operated using the PIP function and the displayed picture DP may be displayed according to a window arrangement environment. Since the window arrangement environment may be dictated by software of the Windows operating system (OS) for controlling the appearance or the layout of the displayed picture DP on the display 102, a program or setting menu may be activated to arrange the window layout based on an arrangement rule of the Windows OS. For example, the arrangement rule may be to equally divide the displayed picture DP into three parts, four parts or multiple parts. Since the arrangement rule of the Windows OS is determined by manufacturers, the user is not able to change or adjust this arrangement rule. Therefore, no matter whether the display system 10 is operated according to the PIP function or according to the window arrangement function, the present invention provides a method which can effectively adjust the layout of the displayed picture.

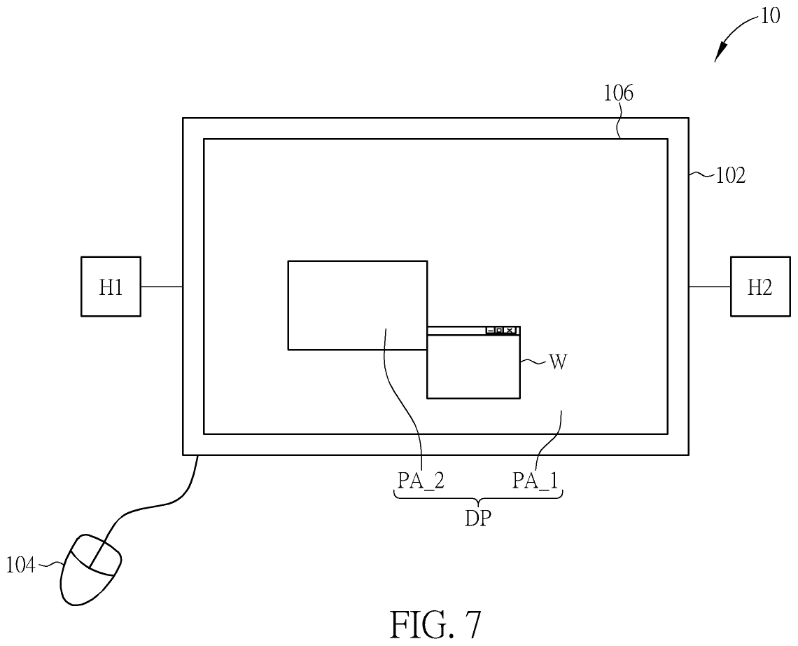

Refer to FIG. 7, which is a schematic diagram of the displayed picture DP of the display system 10 using the PIP function according to an embodiment of the present invention. In FIG. 7, the displayed picture DP of the display system 10 includes the first picture area PA_1 and the second picture area PA_2. Unlike FIGS. 2-6, in this example, the first picture area PA_1 and the second picture area PA_2 are PIP, and the second picture area PA_2 is inside the first picture area PA_1. The first picture area PA_1 is utilized for displaying the image signal from the first host H1 and the second picture area PA_2 is utilized for displaying the image signal provided by the second host H2 inside the first picture area PA_1.

Since the first host H1 may display the appearance of the second picture area PA_2 in the displayed picture DP based on the second location information, when the first host H1 is operated using a particular OS such as Microsoft Windows or MacOS and the displayed picture is in the first picture area PA_1, a window W may be selected by the cursor 108 and moved to a window location, and the first host H1 is configured to determine whether the window location overlaps the second location information. If the window location overlaps the second location information, the first host H1 may determine to transmit the third location information to the display 102, such that the controller of the display 102 may vary the appearance of the second picture area PA_2 based on the third location information. Notably, the above varied appearances may be variations in size of the picture area, turning off the picture area or moving the picture area. In an embodiment, when the window W in the first picture area PA_1 is moved, and the window location overlaps a part of the second picture area PA_2 (i.e. the window location overlaps the second location information), the first host H1 turns off the second picture area PA_2 and displays the second picture area PA_2 at the third location information, which is different from the second location information, and the third location information does not overlap with the window W.

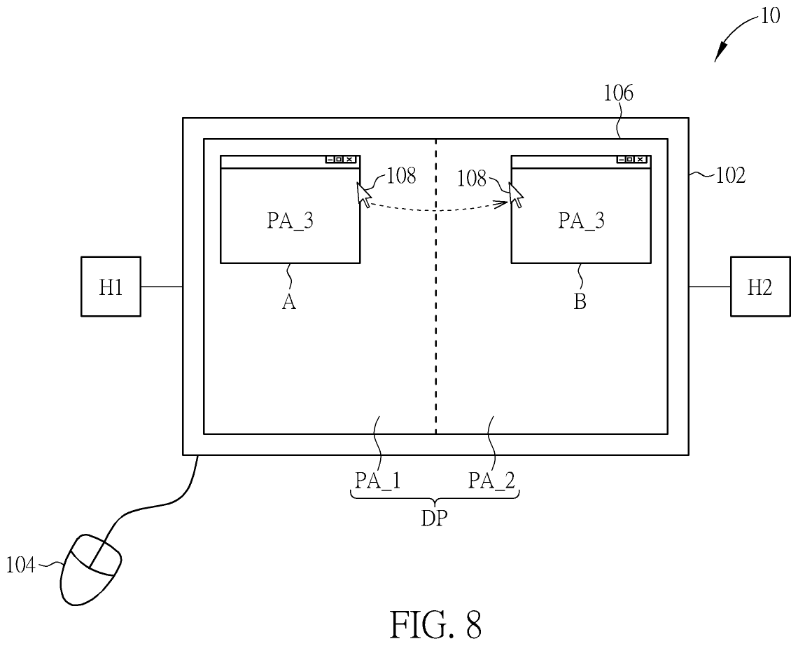

Refer to FIG. 8, which is schematic diagram of the displayed picture DP of the display system 10 using the PIP function according to another embodiment of the present invention. When the displayed picture DP includes the first picture area PA_1, the second picture area PA_2 and the third picture area PA_3, the third picture area PA_3 is operated according to the PIP function. The user may press the mouse 104 or activate a hotkey on the keyboard to select the third picture area PA_3 with location A, and then move the cursor 108 to location Bin the second picture area PA_2, such that the third picture area PA_3 is moved to location B of the second picture area PA_2. Notably, when the third picture area PA_3 is moved from the first picture area PA_1 to the second picture area PA_2, the first host H1 corresponding to the first picture area PA_1 turns off the third picture area PA_3 at location A and then the second host H2 turns on the third picture area PA_3 at location B.

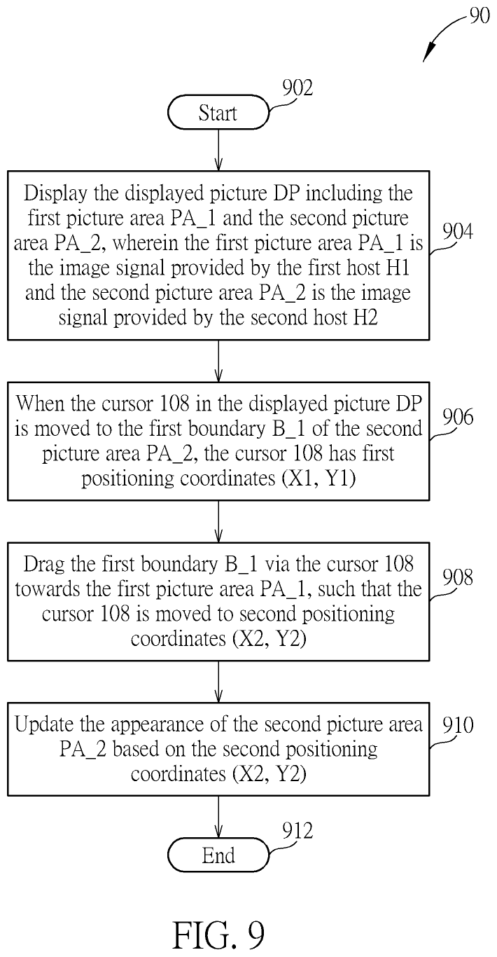

An operation method of the above embodiments may be represented by control processes 90, 1000. The control process 90 is an embodiment of dragging the first boundary B_1 from the second picture area PA_2 towards the first picture area PA_1. As shown in FIG. 9, the control process 90 includes the following steps:

Step 902: Start.

Step 904: Display the displayed picture DP including the first picture area PA_1 and the second picture area PA_2, wherein the first picture area PA_1 is the image signal provided by the first host H1 and the second picture area PA_2 is the image signal provided by the second host H2.

Step 906: When the cursor 108 in the displayed picture DP is moved to the first boundary B_1 of the second picture area PA_2, the cursor 108 has first positioning coordinates (X1, Y1).

Step 908: Drag the first boundary B_1 via the cursor 108 towards the first picture area PA_1, such that the cursor 108 is moved to second positioning coordinates (X2, Y2).

Step 910: Update the appearance of the second picture area PA_2 based on the second positioning coordinates (X2, Y2).

Step 912: End.

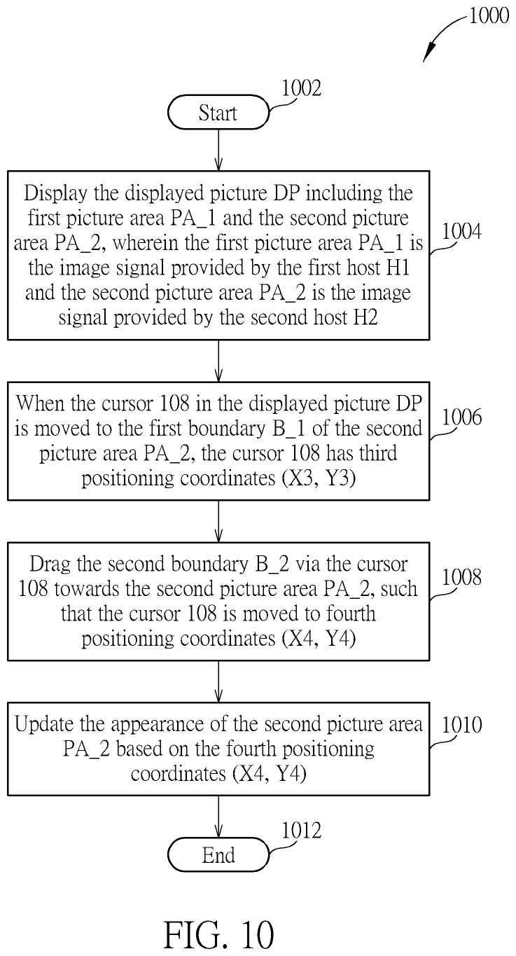

The control process 1000 is an embodiment of dragging the first boundary B_1 from the first picture area PA_1 towards the second picture area PA_2. As shown in FIG. 10, the control process 1000 includes the following steps:

Step 1002: Start.

Step 1004: Display the displayed picture DP including the first picture area PA_1 and the second picture area PA_2, wherein the first picture area PA_1 is the image signal provided by the first host H1 and the second picture area PA_2 is the image signal provided by the second host H2.

Step 1006: When the cursor 108 in the displayed picture DP is moved to the first boundary B_1 of the second picture area PA_2, the cursor 108 has third positioning coordinates (X3, Y3).

Step 1008: Drag the second boundary B_2 via the cursor 108 towards the second picture area PA_2, such that the cursor 108 is moved to fourth positioning coordinates (X4, Y4).

Step 1010: Update the appearance of the second picture area PA_2 based on the fourth positioning coordinates (X4, Y4).

Step 1012: End.

The operation processes of the control processes 90, 1000 have been described with respect to the embodiments shown in FIGS. 2-5, and will not be narrated herein for brevity.

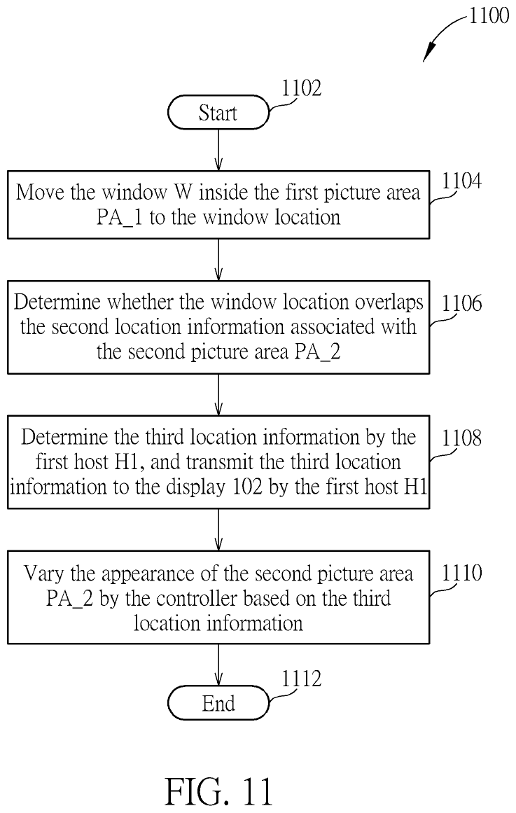

FIG. 11 illustrates a control process 1100 detailing an operation method of the displayed picture DP of the display system 10 operated according to the PIP function, wherein the first picture area PA_1 and the second picture area PA_2 are PIP, and the second picture area PA_2 is inside the first picture area PA_1. As shown in FIG. 11, the control process 1100 includes the following steps:

Step 1102: Start.

Step 1104: Move the window W inside the first picture area PA_1 to the window location.

Step 1106: Determine whether the window location overlaps the second location information associated with the second picture area PA_2.

Step 1108: Determine the third location information by the first host H1, and transmit the third location information to the display 102 by the first host H1.

Step 1110: Vary the appearance of the second picture area PA_2 by the controller based on the third location information.

Step 1112: End.

Details of the operation process of the control process 1100 have been described with respect to the embodiment shown in FIG. 6, and will not be narrated herein for brevity.

The above embodiments illustrate the control method for a displayed picture of a display system, which can effectively adjust the layout of the displayed picture when the display system is operated in specific environments. Notably, the control method for the displayed picture of the display system of the present invention may be implemented in the conventional KVM switching program, or the control method of the present invention may be programmed as an application program and installed on a computer system to execute a corresponding control method for the displayed picture. In addition, a number of picture areas in the displayed picture according to the above embodiments is not limited to two, and the layout is not limited to a side-by-side vertical arrangement. Other numbers of the picture area or different layout arrangements also belong to the scope of the present invention, and are not limited thereto.

In summary, the embodiments of the present invention provide a control method for a displayed picture and a display system thereof, which effectively adjusts the layout of the displayed picture when the display system is operated according to the PIP function or the PBP function to provide greater convenience and ease of use for a user.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A control method of a displayed picture for a display, comprising:
displaying a displayed picture, wherein the displayed picture includes a first picture area and a second picture area, the first picture area displays an image signal provided by a first host, and the second picture area displays an image signal provided by a second host;
moving a cursor in the displayed picture to a first boundary of the second picture area where the cursor has first positioning coordinates;
dragging the first boundary by the cursor towards the first picture area, such that the cursor is moved to second positioning coordinates; and
updating an appearance of the second picture area according to the second positioning coordinates.

2. The control method of claim 1, further comprising:
providing, by the display, a first location information of the second picture area to the first host;
determining, by the first host, the first boundary of the second picture area according to the first location information;
determining, by the first host, a second location information according to the second positioning coordinates and transmit the second location information to the display; and
varying, by the display, the appearance of the second picture area according to the second location information.

3. The control method of claim 2, further comprising:
moving a window in the first picture area to a window location;
determining whether the window location overlaps the second location information or not;
determining, by the first host, a third location information and transmitting the third location information to the display; and
varying, by the display, the appearance of the second picture area according to the third location information.

4. The control method of claim 3, wherein the first picture area and the second picture area are picture-in-picture (PIP) and the second picture area is located in the first picture area.

5. The control method of claim 4, wherein when the first picture area is operated in a window arrangement function environment, the first host turns off the window arrangement function of the first picture area when exchanging picture contents of the first picture area and the second picture area.

6. The control method of claim 1, further comprising:
activating a first hotkey when the cursor is located at the first picture area;
activating a second hotkey when the cursor is moved to the second picture area; and
exchanging picture contents of the first picture area and the second picture area.

7. The control method of claim 1, wherein the displayed picture displayed by the display, the first host and the second host are operated in a Keyboard/Video/Mouse (KVM) switching program environment.

8. The control method of claim 1, wherein the first picture area and the second picture area are picture-by-picture (PBP).

9. The control method of claim 7, further comprising:
moving the cursor from the first picture area to the second picture area;
when moving the cursor to a second boundary of the second picture area, the cursor having third positioning coordinates;
dragging the second boundary by the cursor towards the second picture area, such that the cursor is moved to fourth positioning coordinates; and
updating the appearance of the second picture area according to the fourth positioning coordinates.

10. The control method of claim 9, further comprising:
providing, by the display, a third location information of the second picture area to the second host;
determining, by the second host, the second boundary of the second picture area according to the third location information;
determining, by the second host, a fourth location information according to the fourth positioning coordinates and transmitting the fourth location information to the display; and
varying, by the display, the appearance of the second picture area according to the fourth location information.

11. A display system, comprising:
a first host, configured to provide a first image signal;
a second host, configured to provide a second image signal;
a display, comprising:
a screen, configured to display a displayed picture, the displayed picture including a first picture area and a second picture area; and
a controller, configured to control the first image signal displayed in the first picture area and the second image signal displayed in the second picture area; and
a mouse, configured to move a cursor in the displayed picture to a first boundary of the second picture area and pressed to drag the cursor to the first boundary towards the first picture area, such that the cursor is moved to second positioning coordinates, the controller is configured to update the appearance of the second picture area according to the second positioning coordinates when the mouse is released.

12. The display system of claim 11, wherein the controller is configured to provide a first location information of the second picture area to the first host, and the first host is configured to determine the first boundary of the second picture area according to the first location information, determine a second location information according to the second positioning coordinates and transmit the second location information to the controller, such that the controller varies the appearance of the second picture area according to the second location information.

13. The display system of claim 12, wherein when a window in the first picture area is moved to a window location and the first host determines that the window location overlaps the second location information, the first host determines a third location information and transmits the third location information to the display, such that the controller varies the appearance of the second picture area according to the third location information.

14. The display system of claim 13, wherein the first picture area and the second picture area are picture-in-picture (PIP) and the second picture area is located in the first picture area.

15. The display system of claim 14, wherein when the first picture area is operated in a window arrangement function environment, the first host turns off the window arrangement function of the first picture area when exchanging picture contents of the first picture area and the second picture area.

16. The display system of claim 11, wherein when the cursor is in the first picture area, a first hotkey is activated to inform the controller, and when the cursor is moved to the second picture area, a second hotkey is activated to inform the controller to exchange picture contents of the first picture area and the second picture area.

17. The display system of claim 11, wherein the displayed picture displayed by the display, the first host and the second host are operated in a Keyboard/Video/Mouse (KVM) switching program environment.

18. The display system of claim 17, wherein the first picture area and the second picture area are picture-by-picture (PBP).

19. The display system of claim 17, wherein when the cursor is moved from the first picture area to a second boundary of the second picture area, the cursor has third positioning coordinates, and when the second boundary is dragged by the cursor towards the second picture area, the cursor is moved to fourth positioning coordinates, such that the controller of the display updates the appearance of the second picture area according to the fourth positioning coordinates.

20. The display system of claim 19, wherein the display provides a third location information of the second picture area to the second host, the second host determines the second boundary of the second picture area according to the third location information, and the second host determines a fourth location information according to the fourth positioning coordinates and transmits the fourth location information to the display, such that the display vary the appearance of the second picture area according to the fourth location information.
